(19) United States
(12) Patent Application Publication
(10) Pub. No.: US 2012/0010923 A1
(43) Pub. Date: Jan. 12, 2012

(54) SYSTEM AND METHOD FOR COMMUNICATING WITH INDIVIDUALS

(76) Inventor: Paul M. Yarmolich, Danville, CA (US)

(21) Appl. No.: 13/181,298

(22) Filed: Jul. 12, 2011

Related U.S. Application Data
(60) Provisional application No. 61/363,527, filed on Jul. 12, 2010.
(60) Provisional application No. 61/423,966, filed on Dec. 16, 2010.

(51) Int. Cl. G06Q 10/00; G06F 11/00; G06F 15/16; G06Q 30/00; G06Q 40/00

(52) U.S. Cl. 705/7.32; 705/14.64; 705/32; 705/7.29; 705/39; 709/206; 709/224

(57) ABSTRACT

A system and method for tracking and communicating with individuals located within a business, wherein a business registers with a server or network and transmits messages uploaded to the server through network routers or access points having a SSIDs linked to server and provided to the business.

### RELATED APPLICATIONS

This application claims priority to U.S. Provisional Application No. 61/363,527 filed Jul. 12, 2010 and U.S. Provisional Application No. 61/423,966 filed Dec. 16, 2010, the contents of both of which are incorporated herein by reference.

### FIELD OF THE INVENTION

The present invention is directed towards a system and method allowing businesses to recognize and track the arrival of, and communicate with, individuals through their WiFi enabled devices, and in particular smart phones.

### BACKGROUND OF THE INVENTION

Businesses now, more than ever, have a multitude of ways to advertise and communicate promotions, deals, events, specials, discounts, coupons, or the like with consumers. For example, businesses can now communicate and transmit information to consumers via the internet through: mass emails; through social networking websites like Facebook™, My Space™, Foursquare™, Gowalla™, Placepop™, Yelp™, or Twitter™; through web pages easily accessible to consumers through the internet; through pop-up ads; or through any other electronic media available via the internet. In addition to electronic media, businesses can also still advertise the same promotions, discounts, coupons, etc. through traditional methods like newspapers, television, radio, mailings, fliers, signage or the like.

Through each of these media outlets, businesses typically advertise sales, current or future events or promotions, distribute or provide discount coupons, or display specials. Some business locations, for example amusement parks and stadiums, may use signage to indicate the location of vendors or attractions. For example, signage in an amusement park may indicate in which direction a particular food or drink vendor is located.

While such types of communication have proven successful over the years, each has one major downfall—there is no way to insure that a consumer receives the message, discount, coupon, or other necessary information on site, i.e. when located within the interior of the business. For example, a consumer in a department store, grocery store, electronics store or the like may not receive any notification of an ongoing sale or coupons for goods located within the store while one site. While stores may advertise with signage within the store to indicate sales or discounts, or provide coupons somewhere near an entrance or a particular item, there is no guarantee that the consumer will ever see the signage or the coupons, leaving the consumer unaware of any sale or discount. In some cases, if a consumer frequently visits the same store, the consumer may know the location of any coupons the store provides, however, even though the coupons may still be valid, there may not be any coupons left for the consumer to utilize.

In order to overcome the problem of consumers missing out on valuable discounts provided by coupons, some businesses, like for example grocery stores, have done away with coupons and provide a “membership” or “club” card which allows any consumer with a card to automatically take advantage of any sale in the store. Such systems are still flawed, however, because consumers may be unaware of certain items being on sale, even with the card. In many of these situations where a card is utilized, consumers either have to see an advertisement in, for example, a newspaper, or have to physically walk by a sign indicating that the item is on sale in order to discover that their card would entitle them to a discount for that particular item. In addition, many of these cards are only valid at one particular business location. This requires consumers to have to sign up for, maintain, and carry multiple cards in order to receive the appropriate discounts at each business the consumer frequents.

In the case of signage directing individuals to specific locations like, for example, vendors in an amusement park or stadium, in order for a consumer to be aware of the sign and location of the vendor, the consumer is required to walk by the sign or vendor and view it. While signage may be successful in some cases, in other cases, like for instance if a group of consumers is standing in line to enter an attraction or sitting in their seat and a sporting event, they may have no idea which vendors are located nearby from which they could purchase, for example, food and/or beverage. The location of these vendors may be unknown to consumers and as such, consumers may not be able to find them. While signage around an amusement park or stadium may help those who are currently moving, for those standing in lines or sitting in seats, signage fails to direct consumers.

Likewise, electronic media is unlikely to reach a consumer while he or she is located in a business. If, for example, a business emails coupons to consumers, or advertises daily specials through a social networking site, consumers would still have to sign into their email or social networking account and review each message to determine if a coupon has been emailed to them or a special discount exists. For consumers who receive emails and/or updates from social networking websites via their phone, in order for such emails and/or updates to be useful at the business, the consumer would have to receive the email and/or update while in the business, or track and remember a coupon or discount previously received. Unless businesses have someone continually emailing coupons and/or providing updates through websites like Facebook™ or Twitter™, there is no way to insure that each consumer is notified of any potential discounts or promotions while on site. While many cell phones nowadays have the potential to be communicated with in real time, presently there is no way to insure that all consumers are provided with any such communications while on site.

Another problem with each of the aforementioned types of media is that they require the consumer to undertake some effort to find out about sales or events, to clip and carry coupons to a location, or to seek out signage or information once on site regarding potential deals, specials, or the like. For example, in order to utilize coupons a consumer may be required to bring a mail flier into the business with them, or go through a newspaper, select the coupons for the business they are traveling to, and bring them to the store. In such situations consumers are not only required to bring coupons to each store with them, but consumers also risk misplacing or losing additional coupons as a result of transporting, clipping, or utilizing any coupons provided to them. For any coupons which are emailed to consumers or provided through social networking websites, consumers are required to print the coupons and bring them to the store in order to receive their discount.

As mentioned above, for items like “membership” cards or rewards cards, consumers are required to sign up at each individual business from which they want to receive advantages. Such requires time on the part of the consumer, and in some instances, requires the consumer to provide information to a business that the consumer may prefer to keep confidential.

In addition to carrying “membership” cards or rewards cards, some consumers may additionally have to carry any credit or debit cards the consumer wishes to use to pay for any purchased items or services. Though not related to consumer purchasing, may consumers may also have to carry key fobs or electronic key cards for entry into their homes or businesses. These are just a few of the additional items that an individual has to remember and keep on their person in order to carry out day-to-day life.

An additional problem facing businesses today is the consumption of energy and reducing the amount of energy used by employees. While wireless systems and sensors controlling lights or heating or air conditioning may be utilized, the present systems fail to provide energy at all times while an employee or consumer is in a particular location and cease providing power as soon as the building or room is vacated by all individuals.

In view of the foregoing, it would be advantageous to have a system and method whereby businesses can communicate deals, events, promotions, specials, locations of vendors, personalized messages, or any other information directly to consumers while they are located within the confines of the business. It would be a further advantage if such a system could operate with minimal time and effort on the part of the consumer and remove the necessity of the consumer having to consult or review outside media. If would also be advantageous to create a system wherein consumers can register with a single entity and receive discounts and information at numerous businesses. If would be further advantageous to create a system where something a single electronic device may be used to receive information directly from businesses, provide payment for any purchases from businesses, and control any electronic entry points an individual encounters. If would be further advantageous if the system could control utilities in a building and insure that power consumption is reduced and minimized if no employees or consumers are located within a business or within a particular area of a business.

The present invention is provided to solve these and other issues.

### SUMMARY OF THE INVENTION

According to one aspect, the present invention is directed to a system and method whereby businesses may communicate with individuals on site. As used herein, the term “business” or “businesses” includes any area, indoors or out, utilized by any public or private entities other residences. In one embodiment, businesses register with a central server which oversees a network through which information is provided to individuals. After registering, businesses may upload any information or messages they wish to provide to individuals, employees, or consumers who enter their business. In order to enable the messages to be transmitted to the individuals, each registered business may be provided with at least one router or WiFi access point linked with the central server through the internet wherein the at least one router or access point is capable of transmitting messages to smart phones or other WiFi enabled devices.

According to another aspect of the present invention, an individual may provide information to a central server through, for example, the internet, an in-store electronic device connected to the server, or through their smart phone or WiFi enabled device when entering a business linked to the network. Registration allows the individual's cell phone and in particular smart phones or other WiFi enabled devices, like for example a PDA or a tablet or laptop computer or a WiFi ID card provided for access to the network, to receive messages from and communicate with the network. It should be appreciated that as used herein the term “individual” may be any person, including consumers or employees, or entity owning a WiFi device capable of communicating with a WiFi network. In order to take advantage of the network, an individual may be required to provide their name, email address, and cell phone number.

According to one aspect of the invention, the routers or WiFi access points linked to the server/network contain identical SSID's. The routers or access points are placed in businesses who wish to communicate directly with individuals who are currently on site. Once the individual has registered with the network, every time the individual enters a business containing a network router, the network will recognize the unique electronic ID of the individual's cell phone or other WiFi enabled device, and will provide information to the individual. By linking each router together and giving each a common SSID, individuals do not have to worry about specific cards, coupons, or logins for each store—so long as the individual carries their smart phone or other WiFi enabled device into each business, the individual will receive all information and discounts provided by each business containing at least one network router.

According to another aspect of the invention, the network may assign a unique user ID code or name to each smart phone or other WiFi device when it is registered with the network. Rather than use an ID already stored on the smart phone or WiFi device, the network may assign a unique ID to each new smart phone or WiFi device when it is entered into the network.

According to another aspect of the invention, the network may also work with multiple SSID's. For example, if one set of particular business or group of businesses use the system and with a different SSID, the network may be configured to link the customer as being at the store through the server. Each new or unique SSID may be added to the network individual. Where a particular business utilizes its own SSID, an individual would have to re-register with each unique network in order to receive messages from the particular business. According to another aspect of the invention, the individual may be able to configure their smart phone or other WiFi device to recognize the unique SSID and be have their account linked to the unique SSID through the network and server once the individual signs on to the SSID.

According to one aspect of the invention, the routers or WiFi access points may be configured to provide a generic greeting or a sample discount or discounts to each individual who enters the business in order to welcome individuals and enhance each individual's experience, regardless of whether or not they are registered with the network. Such generic messages may include an option for the unregistered individual to opt out of future messages from the network, or merely opt out of messages from that particular business or contain a link for the unregistered individual to register. In yet other embodiments, the routers or access points may be configured to provide every message to every individual who passes each router or access point.

According to one aspect of the invention, individuals entering a registered business may be automatically provided with notifications of specific sales, insuring that the individual is aware of sales going on in the store, allowing businesses to efficiently communicate with individuals, and provides the individual with any required coupons, removing the individual's need to find and carry any coupons with him or her.

According to another aspect of the invention the network may allow businesses to provide information and promotions regarding upcoming events or the status or current events.

According to another aspect of the invention, a business may track individual's movements and time utilizing registered WiFi devices.

According to another aspect of the invention, a business may control energy usage by linking utilities, like for example lights or heating or air conditioning to the network. The network may be configured to, for example, detect the presence of any WiFi devices in a particular area. If no WiFi devices are detected, the network may power off the lights or adjust the temperature of the room directly, or by sending a control signal to another control device connected to the utility to be controlled.

According to another aspect of the invention, network routers or access points may be provided near electronically locked doors. The network routers or access points may be configured to unlock the electronically locked door if any WiFi device approaches the door, of only if specific, pre-approved WiFi devices approach.

According to another aspect of the invention, the network may be configured to determine if a particular individual or individuals are within a particular business, room or area. If the network determines that a particular individual or a demographically slanted group of individuals, like for example predominately men or predominately women, specific messages or programs for an individual, or demographically tailored messages for a group of individuals may be provided, For example, information about men's or women's clothing may be provided on a visual display, like for example a video screen or on a television. Alternatively, a personalized message may be provided on, for example, a kiosk screen or a display on an ATM or gas pump when a specific individual approaches. It is further contemplated that in embodiments used in particular businesses or even homes, that the menu or guide on a television or music playing device, for example, may be customized and tailored depending which individuals are identified as being near the television or within a listening area.

Other advantages and aspects of the present invention will become apparent upon reading the following description of the drawings and detailed description of the invention.

### BRIEF DESCRIPTION OF THE DRAWINGS

FIG. 1 shows a flow chart describing the basic principles of the invention.

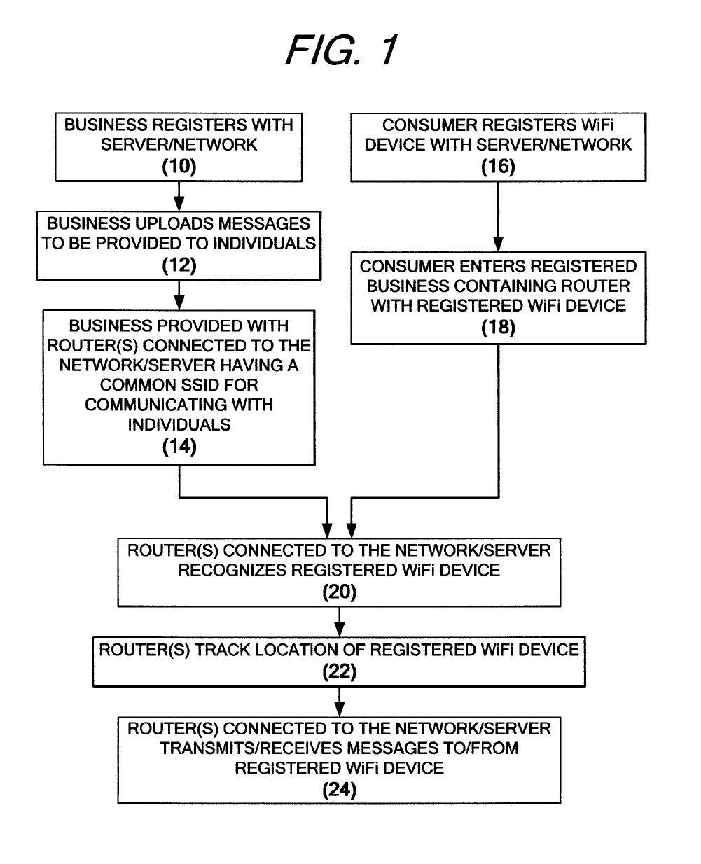

FIG. 2 shows a business set up using the current invention.

### DETAILED DESCRIPTION OF THE PRESENT INVENTION

While this invention is susceptible to embodiments in many different forms, there is described in detail herein, preferred embodiments of the invention with the understanding that the present disclosures are to be considered as exemplifications of the principles of the invention and are not intended to limit the broad aspects of the invention to the embodiments illustrated.

The present invention allows businesses to recognize the arrival of any consumer, customer, employee, or other individuals at their businesses through the recognition of the unique electronic identification of each individual's WiFi enabled phone or other portable WiFi enabled device. In essence, each WiFi enabled phone or WiFi device contains a unique electronic RFID tag located in an individual's pocket or bag which may allow a network to recognize who each individual is, and where each individual is located within the business. Such also allows the business to interact with each individual through the phone or WiFi enabled device while the individual is located on site.

Businesses which seek to communicate with individuals on site may join the network by registering with the server and network (10) via the internet, telephone, or any other means of communication known in the art. In some embodiments, businesses may be provided with an account login and/or password to allow the business to access its account in the network once the business is registered. Once a business has registered (10), the business may begin uploading messages (12) to the network/server it seeks to transmit to phones or other WiFi devices within the premises of the business. Messages may be uploaded to the server using any means known in the art including but not limited to, by accessing the server through the internet, by a phone call or email to a network administrator for entry into the server by a remotely located person or computer, or through the use of social media websites linked to the businesses account.

In order to insure that the uploaded messages (12) are communicated to individuals while on the business premises, each business is provided with one router or multiple routers or access points (14). In a preferred embodiment, each router or access point has a common SSID, however as described herein it is contemplated that a business or a group of businesses may contain a special or unique SSID for all of its customers or for specific customers who may receive a password other way to access the network through the unique SSID. At least one router or access point of the router(s) provided to the business must be connected to the internet to retrieve any messages uploaded to the server by the business. In order to insure that the proper messages are provided to the proper routers and/or businesses, each router or access point connected to the server is provided with a specific identification element, like for example, an IP address, a MAC address, a stored login and/or password, or other means known in the art which allows the server to identify which router or access point is requesting information and which router or access point the server is providing the information too. While each router and/or access point contains some means of identification to insure that the right routers are transmitting the right messages or information, as further in more detail below, every router provided to every business contains a common SSID.

In some embodiments it may be desirable to have sub networks where different sub networks have distinct SSID's across a business, or a specific business or a group of businesses have a unique or distinct SSID. Such would be advantageous in situations where a business wanted a private network rather than participating in a nation wide or global network, or for private labeling of a product or enhanced customization of providing content to its customers or other individuals located within the business. The data may be aggregated at the server and treated as one for even sub networks if this is desired. As should be appreciated by those having ordinary skill in the art, each router or access point may be capable of transmitting and recognizing two SSIDs, allowing a business to communicate using two separate SSIDs off of a single network or routers.

Utilizing a sub network may be advantageous for businesses who wish to provide special offers or information to select individuals, for example multiple repeat customers or employees. As should be appreciated by those having ordinary skill in the art, the sub network may be provided with a password or other network protection to insure that only the selected individuals receive the tailored messages. Inasmuch as the network is able to determine each router or access point it is providing information to, the specific messages for specific SSIDs may be provided and kept separate as a business desires.

In embodiments where multiple routers or access points are utilized, the routers or access points may be configured so as to only transmit a message (24) when a consumer passes or reaches a certain point, like for example when the consumer enters or exits a business, or enters or exits a line or other location within the business. Such routers or access points may be set up to provide a welcome or thank you along with coupons for that visit to the business, or future visits to the business, or provide information specific to that location, like, for example, the wait time before the entrance to an attraction.

In alternative embodiments multiple routers may be used to provide area specific information to individuals within the business. For example, in large scale department or discount stores, one router or access point may provide details regarding furniture to individuals located within a furniture showroom, while a second router or remote transceiver may provide details regarding jewelry to individuals located near jewelry counters. Additional routers or access points may be positioned, to provide details regarding any department within the store, like, for example, men's or women's clothing, shoes, cookware, electronics, lawn and garden items, or any other products the department store sells. In such embodiments, individuals may be provided with only the information relevant to products in the area they are currently shopping and not bombarded with information regarding all of the products a large store may sell. Alternatively routers or access points may be set up as beacons to provide information about a specific product or to notify of a sale on a specific item as an individual walks by the item in the business. As should be appreciated by those having ordinary skill in the art, the strength of the signal provided by any individual router or access point may be adjusted to conform to its particular use.

In embodiments where multiple routers or access points are used, each router or access point will have a separate means of identification as described above, and may be in communication with each other. Placing each router or access point in communication with another enables to the business to transmit one or multiple messages so long as only one of the routers or access points is connected to the server through the internet. So long as a single router or access point is connected to the internet and all other routers or access points are in communication with the connected router or access point connected to the internet, information from the server may be retrieved and transmitted from any router or access point. Such allows for the business to track and store each individual's movement and time spent in the business's premises, and allows the business to retrieve an individual's personal information provided to the server and provide personal messages to each individual at each point while minimizing any hard wiring requirements or internet interruption restrictions. Connecting a single router or access point to the internet also cuts down on wiring and internet access requirements and bandwidth requirements in the business.

While at least one router or access point is connected to the internet, as should be appreciated by those having ordinary skill in the art, the routers or access points may be configured to deny internet access to any or all individuals WiFi devices internet access. The routers or access points may be configured to allow unauthorized WiFi devices only a local area network (LAN) connection, preventing any individual from utilizing the businesses internet connection and bandwidth.

It is contemplated by the invention that in businesses where not internet access is granted that information may be transmitted using a 3G or 4G network through direct text messaging, email or the like. In such systems, the routers or access points in each business would be used to communicate with the smart phone or WiFi enabled device, however the routers or access points may stop short of authenticating the smart phone or WiFi device. In such embodiments, the smart phone's or WiFi device's 3G or 4G network may be used to send and receive text messages to and from the network for communication without actually using the WiFi signal or granting any access to the internet.

Placing the routers in communication with each other also allows the network to track and pinpoint the location of individuals located within the business (22). In businesses where multiple routers or access points are used, the network routers or access points may be configured to mesh or have overlapping signals, allowing the routers or access points to triangulate or pinpoint the location of a smart phone or WiFi device utilizing signal vectors. For example, in one business nine routers or access points may be in communication with each other and configured such that at any given point at least two routers, and more likely more than two routers, are in communication with a smart phone or other WiFi device or the routers are sequestered in rooms indicating which room an individual may be in. Having at least two routers in communication with each other and any smart phones or WiFi devices in the area, allows the location to be pinpointed by the network. Utilizing such embodiments allows the network to provide directions to an individual or provide messages or discounts for products located near the consumer's position, while also allowing businesses to control areas typically not available to the general public or any individuals not associated with or authorized by the business.

Alternatively, the location of a particular individual may be determined from the individual's smart phone or WiFi enabled device. As should be appreciated by those having ordinary skill in the art, many smart phones are capable of transmitting the location of the phone in order to determine the phone's location. Such information transmitted from the phone may provide the system with the individual's location, and allow the system to determine which business the individual is currently located in. The network may also be configured to determine a total number of individuals within a given business or room within a business based on the number of individuals in communication with the network.

As indicated above, all routers connected to the server/network may have the same SSID. Every router in every business having the same SSID allows individuals to move from business to business and connect to the network every time after registering the first time. The routers are configured in such a manner that upon recognition of the individual, the server is immediately able to determine which router the consumer has connected to and at which location the individual should be communicated with, utilizing the aforementioned router identification method.

It should further be appreciated by those having ordinary skill in the art that the status of each of the routers are tracked by the network server. If, for instance, a server recognizes that a particular router has malfunctioned or lost power, the server may be programmed to provide a message to business notifying the business that one of the businesses routers is not operating properly, allowing the business to facilitate the immediate repair of the its router.

The routers or access points may additionally be provided with a back up power supply, like for example a battery, to insure important information is transmitted to individuals in the event of a power outage or an emergency. A single back up power supply may be provided for all routers within a given business, or each router may contain its own power supply. Alternatively, it is contemplated that only certain routers are provided with back up power supplies while the remaining routers are left unpowered in an emergency.

Examples of messages or information which may be uploaded by the business to the server and provided to individuals through the network routers includes but is not limited to sales, coupons, specials, or other discounts on products or services offered in the business, the status of an event or the current conditions in the business, the wait time for a particular event or entrance into another area or location of the business, the availability of a specific individual in the business, short movies or explanations provided to individuals for entertainment or informational purposes, and the availability or location of a new or hot product at that store or a related store.

For example, as an individual enters or exits a business, they may be provided with a list of items which are currently on sale in the business or a group of downloadable coupons for discounts on products or services.

As another example, messages may be periodically provided to an individual to update the status of a particular event, new deals within the business, or the location of vendors in the surrounding area. For example, if the individual is in an amusement park and waiting in line or walking towards a particular ride or attraction, the network may send a message to the individual's WiFi device indicating how long the wait is for the attraction and where nearby food and beverage vendors are located. The network may also track the amount of time an individual has spent in a line and offer to send a multimedia message or link to a video to help pass the time. The network may also send a fast-pass message when the individual has left the ride, directing them to the next ride with the offer of a reduced wait or free passes for other attractions or discounts on food or drink. Such is advantageous for individuals who wish to take advantage of a park's attractions but also need food or a beverage. In some embodiments a consumer may enter a line for a roller coaster and be provided with information that there are 200 people in line in front of him and the current wait time is approximately 1.5 hours but that the next roller coaster in a particular direction only has 30 people in line and a 15 minute wait. The message may further provide the consumer with a line pass for returning to the roller coaster with a 1.5 hour wait if the consumer chooses to take advantage of the 15 minute wait at the next roller coaster.

In locations like a bar or restaurant, information may be periodically transmitted to the individual's WiFi device to, for example, indicate updated food or drink specials, the status and start time of entertainment for the evening, or if a particular game, sport, or show is being shown on a particular television within the establishment. In addition, since the network is able to determine when an individual is leaving a business, the network may provide information about future entertainment, events, or offers around them that they may have not been aware of while in the business.

While the examples of an amusement park or bar or restaurant is used above, it should be appreciated that the network may be used to provide a wait time or event status or any other announcements or information related to any business may be transmitted in a similar manner for any business.

In yet another embodiment, the present invention may be used to transmit updated information in real-time related to a particular business based the individual's actions or location, or even current conditions or the status of a particular business feature. For example, in an alternative embodiment the network may transmit updates to consumers on a golf course including warnings about weather detected by the network or provided to the network through the internet. The network may also provide messages regarding pace of play—either for the groups in front of the individual or if the individual them self is playing too slowly. In addition, a message could be transmitted to the consumer indicating that the consumer is approaching a particular location, for example the ninth hole of a golf course, and remind the consumer to get his or her food and/or drink order in to the clubhouse to avoid any unnecessary delays when approaching the back nine. The system may also be configured to transmit messages at specific locations providing a consumer with information related to his specific position, like for example, that the consumer is 150 yards from a green at a golf course, or that the fairway dog-legs left behind a group of trees.

In order to be insure that a WiFi device is recognized by the network and to take full advantage of discounts or other information provided by businesses on the network, an individual may join the server/network by registering their phone's or WiFi device's MAC address or other electronic ID, phone number and email address (16). Registration may be done either automatically at a site where the network is present, or through a web page accessible via the internet. In order to join the network, the consumer must provide their name, email address, and cellular phone number. When done onsite, the MAC Address may be automatically determined by the WiFi router and server/network. If registration is completed offsite, like for example through a website accessed at the individual's home, the individual may be required to manually enter the MAC address or other electronic ID of the associated WiFi device at registration. Alternatively, the individual may be provided with a confirmation number or code to input on their WiFi device the next time the WiFi device is within range of a router or access point. Inputting the confirmation number or code will link the MAC address or other electronic ID of the device to the individual's account associated with the information previously stored in the network.

It is also contemplated that the network and/or server may assign a unique ID to each smart phone or WiFi device that is registered with the network. As each device is registered, the network may assign a unique ID to the device in order to recognize the device as it moves in and out of the network and to track any referrals, purchases, or research or other data associated with the registered users account.

When registration is completed within a business linked to the network, registration may be completed as follows. An individual within a business on the network may receive a prompt to join a WiFi network given the SSID of the network when entering within range of a network router or access point. When selecting the network SSID, the individual may be prompted to enter the cell phone number. After receiving the cell phone number, the network may provide text message having a link for the individual to register with the network. The individual may link from the text to a registration, enter a name and email address, and the network will do the rest, i.e. detect the smart phone's or WiFi device's MAC address or other electronic ID. Once registration is complete, the individual will forever be connected to network through all routers having the network SSID through which the individual signed up.

As should be appreciated by those having ordinary skill in the art, an individual may be required to re-register or sign up for any unique SSID's linked through to the network when prevented with such. For example, if a particular business has a unique SSID, in order for information to be transmitted to an individual on site, the individual would have to re-register with the network, or alternatively configure their device to recognize the new SSID. Once the individual recognizes the new SSID, the network and server may link the individual's account to the individual's device utilizing the MAC address or other electronic ID, insuring that the individual is recognized while in the business containing the unique SSID.

In alternative embodiments, individuals may download an application (“APP”) to access the network. After the APP is downloaded, the individual may be prompted to join when first opening the APP. Once joined the individual's network accessibility and interaction may follow as described herein. In embodiments where an APP is required, the network may be configured to start the APP on each registered individual's smart phone or other WiFi device each time the device comes within range of a network router or access point.

In alternative embodiments, individuals may be provided with an opportunity to purchase a network linked WiFi identification card if they do not have a WiFi device or do not want to register their WiFi device with the network. The WiFi ID card may contain display screen for viewing messages provided by businesses. Alternatively, a scaled down WiFi ID card may be provided, allowing the individual to store information on the network and receive discounts and rewards, but not be provided with point-of-sale information. In such embodiments, emails or the like may be transmitted to the individual to insure that the individual is periodically provided with information regarding upcoming sales or events.

The routers can operate with open source Open-Mesh software and a very light web server whose purpose is to ascertain the users MAC address during the registration process. The web server or other process is needed due to NAT (Network Address Translation) which often modifies the network address information in datagram (IP) packet headers while a device is in transit across a traffic routing device such is done for the purpose of remapping one IP address space into another. By getting this information, the network can identify which router the registration is coming from, and therefore associate the cell phone with its MAC address. The web server captures the data needed and appends it to a transport stream for identification at the server. Once a cell phone has been identified, it is tracked no matter which router within the network it is connected to.

The network communicates with individual's WiFi devices as follows. The network routers identify the MAC address of registered WiFi devices as they move in and out of any individual router's range. The routers are capable of detecting any registered WiFi devices which are in range, how much data the WiFi device transfers through our access point, and even which URL's a WiFi device has been used to access to determine the individual's interests.

Once an individual has registered their smart phone or WiFi device, every time they enter a business containing at least one network router (18), the individual's smart phone or WiFi enabled device will be instantly recognized (20) and the WiFi device will be tracked throughout the business (22) and the router will transmit a message containing information to the consumer (24). As should be appreciated by those having ordinary skill in the art, using a network router and a smart phone or other WiFi enabled device also enables the consumer to transmit messages to, or respond to any messages from, the business. Once registered and recognized on the network, the consumer will be able to use his or her smart phone or WiFi device to engage in two way communication with the business.

It should be appreciated by those having ordinary skill in the art that at the time of registration, an individual may provide additional information in order to tailor the messages the individual receives to the individual's particular interests or needs. For example, an individual may alternatively provide additional information, including but not limited to age, gender, a mailing address, additional phone numbers, a list of products or services they are interested in or frequently purchase, information about what products they may be interested in purchasing in the future, clothing or shoe size, dietary needs or restrictions, what pets or animals the individual owns, what types of food, movies, or music the individual prefers, or any other information which may indicate any products or services which the individual may or may not be interested in. If an individual has provided information regarding products or services they prefer, messages may be transmitted which are specific to the individual's interest. For example, if an individual enjoys a particular type of music, then information regarding the preferred type of music, i.e. new releases within the genre or by certain artists, may be transmitted to the individual's cell phone as soon as the individual enters a store selling music. Such notifications insure that the individual knows that the newly released products or services the individual may be interested in are communicated directly to the individual while they are located in a business.

Individuals may also provide the network with payment information, like for example a linked debit card or credit, to eliminate the necessity of the individual of having to carry a debit or credit card to each business they may purchase an item from. If an individual chooses to input payment information into the network, the individual may be given an option of linking a debit or credit card to their account so as they approach a check out area at a particular business their smart phone or other WiFi device is recognized by an access point located at the check out, and the individual is only required to select which linked card they would like to provide payment with and either enter a pin number or sign their name. Since each smart phone or other WiFi device has a unique MAC address, each can be linked to one or more accounts that will only be accessible to the individual carrying the smart phone or WiFi device.

Alternatively, individuals may input payment information in order to prevent fraud, whether it is a credit or debit card or some other method of payment. In such systems, in order for a credit or debit card, for example, to be accepted at a payment kiosk, the linked WiFi device must also be present. If both the credit or debit card and the linked WiFi device are not present, then payment from the credit or debit card will not be accepted.

Registering with the network may also provide individuals with enhanced control over the content of, or number or frequency of, the messages received. Registered individuals may also be provided with the ability to block messages for a specified period of time, or regarding certain types of products, or messages from specific businesses registered in the network.

Once an individual has registered with the network, anytime the individual enters any business containing one of the linked routers, a personalized text message, email, phone call with a recorded message, or some other form of communication may be transmitted to the individual's smart phone or other portable WiFi device as soon as they enter the business.

For example, registered individuals may periodically receive communications transmitted from the network for as long as they remain within the business, or even when they exit the business. As an example, once an individual enters a grocery store, upon entry the individual might receive a communication welcoming the individual and indicating the sales for the day. In situations where a coupon is needed, the coupon may also be provided via the communication through, for example, a downloadable document, a barcode, or a verbal keyword passed along in a recorded message. In alternative embodiments no coupon may even be required—as soon as the network recognizes that a individual is in the store, the individual will receive all discounts simply by, for example, entering their cell phone number or email, or scanning a bar code on their cell phone at check out. Once the WiFi device is checked in, all store discounts will be applied to all purchases for that individual regardless of required coupons or the like. In yet another alternative embodiment, additional routers or access points may be located near check out counters which can detect that a registered individual is checking out and all of the business' discounts can automatically be applied to the individual's purchases.

Registering with the network using a specific WiFi enabled device having a MAC address may also enable to the individual and their WiFi enabled device to be selected for specific or special rewards, announcements, or be provided with other information. For example, existing individuals linked to the network may refer an unregistered individuals to the network and receive or be selected for special referral reward offers. The referrals may be accomplished by either, the previously registered individual providing an unregistered individual's contact information, like for example a name and cellular phone number or email address to a business in the network or to the network directly. Alternatively, the registered individual may inform an unregistered individual of the network and/or specific offers from businesses in the network, encouraging the unregistered individual to register with the network on his or her own, entering referring registered individual's information, like for example the existing individual's cell phone number associated with the network. Upon entry of the previously registered individual's information by the newly registered individual, the network may be configured to provide a special referral reward offer to the previously registered individual.

As should be appreciated by those having ordinary skill in the art, businesses may have the option of providing the special offer to the previously registered, referring individual at any time, like for example immediately upon the registration of the newly registered individual on the network, or after the newly registered individual has entered the business location and received an offer or message from the business, or alternatively, after the newly registered individual has made a purchase from the business.

Businesses may further have the option of providing a referral reward offer to any selected individual who merely refers any new consumer to the network in general, or in the alternative, may only provide the referral reward offer to previously registered individuals whose referral is linked to a particular business or particular businesses. For businesses where a reward is only provided for a referral to particular businesses, a newly registered individual may be required to enter the business name and/or establish the existing registered member who referred him or her to when the new individual registers with the network. For businesses requiring specific referrals, the newly registered individual may have to enter the referred business and/or offer when entering the previously registered individual's information in order to insure that the previously registered individual receives the referral reward offer from the business. Where referral rewards are only linked to specific businesses, when joining the network, newly registered individuals may be provided with an opportunity to enter numerous businesses or offers, allowing the previously registered individual to receive multiple referral reward offers from multiple businesses for a single referred individual. The network may also be configured so that referral rewards may be provided for businesses in addition to the business the newly registered individual was referred to. For example, if a newly registered individual lists business A as the referred business when joining the network, the previously registered individual may receive a reward offer from businesses A, B, and C.

As should be appreciated by those having skill in the art, in embodiments utilizing a referral reward offer, the network may be configured to track referrals between individuals. Tracking referrals between individuals provides businesses with the opportunity to offer additional and/or more lucrative offers to individuals who refer multiple new individuals to the business or network and insures that previously registered individuals receive the referral reward offers for helping the business attract new individuals. Tracking also insures that existing and new consumers do not take advantage of the referral system and repeatedly refer each other.

In alternative embodiments, existing registered individuals may be selected to receive rewards based on past or present purchases. For example, if an individual having a registered smart phone or other WiFi device purchases an item from a business, the individual may receive a message providing a future discount as a reward for their previous or current purchase. The reward may be provided after, for example, a specific number of purchases or after an aggregate dollar amount has been spent by the individual at a particular business offering a reward as tracked by the network. The rewards may be general discounts on any purchase from the business offering the reward, or may alternatively be linked to specific products related to the individual's past or present purchase, like for example a discount on a surround sound system after purchasing an high-definition television. As should be appreciated by those having ordinary skill in the art, any discounts or rewards may be automatically applied to the individual's next purchase from the business, or alternatively may be saved and aggregated for larger discounts or better rewards.

In some embodiments, individuals owning WiFi devices that are registered with the network may be selected at random to receive special offers, discounts, or even products. For example, a particular business may transmit a message to the 1,000th customer every day offering a $5 discount on their purchase that day.

Depending on the amount of information an individual provides to the server, registration of the individual's WiFi device with the network may offer alternative means of communication between the individual and the network. For example, one way the network may interact is by automatically registering or signing in the individual's arrival with any social networking site known in the art. Examples of social networking sites include, but are not limited to Foursquare™, Gowalla™, Placepop™, Yelp™, My Space™, Twitter™, and Facebook™. Registration or sign in can be done automatically by the network and does not require the consumer to do so manually. The network automatically signing the individual in insures that the network will have direct contact with the individual on site.

Registration with the network also allows for continued contact with the individual in the event that a social networking site ceases to exist or the consumer decides to close his or her account with the social networking site, close an email account, or change their phone number. Since the network has additional information to contact each consumer, a direct line to and from the individual will exist both onsite, i.e. at the business location, and at home. Notwithstanding social networking sites, it should be appreciated by those having ordinary skill in the art that communication between the network and a individual's WiFi may be accomplished through any means known in the art, including but not limited to text or picture messages, phone calls with recorded messages, emails, messaging programs, through direct connection to the recognized MAC address on site or the like.

It should be appreciated by those having ordinary skill in the art that use of the network does not require the download or installation of any applications on the individual's WiFi device. Like with any router, the individual merely needs to use the network SSID. Once an individual registers their WiFi device on one of the network routers or with the server, the WiFi device is registered for all routers within the network since all routers have a single SSID. An individual will never have to sign in, register, or otherwise interact with the network until the network attempts to communicate with the individual. At that time the individual will only be required to read a transmitted message from the business and respond or act accordingly.

Registration may also allow individuals to transmit messages to the business or respond to select messages received from the business. For example, in a restaurant, upon entry an individual may receive information regarding the specials for the day and a prompt to input the individual's food and/or drink order. After reviewing any information provided by the restaurant, the individual may then provide a response through the system wherein the individual places their order without having to wait in line, or for a drink or appetizer while the individual waits for a table. Additional information relative to the order may then be provided by the restaurant, like, for example, wait time for the individual's order, the amount the individual owes for their order, an order identification number, the amount of time the individual will have to wait for a table, or the like. Registered individuals may also be presented with customized messages where the prompt for ordering a food or beverage, for example, includes a response for the regular if there is a food or beverage the individual typically orders.

Registered individuals may also be able to use the network to track and record their own market research or other product or service information the individual may be interested in. For example, the network may be used by individuals to research and track homes they are interested in. A router may be placed at each of the houses which registers the potential buyers viewing the property with the central server. The central server may be configured to send immediate data about the property to the individual or even data about alternative properties in the area. Once through touring the properties, the individual may access their account to review the homes they have looked at or be sent a list of the properties viewed with additional links to data about the properties, the neighborhood, local schools, or any other type of data related to the home buying process. As should be appreciated this functionality for registered users is not limited to just the home buying market but may be utilized in any product or service market which an individual may wish to shop around or be provided with additional information on each product.

While much of the foregoing has been directed to individuals who are typically consumers obtaining a discount for obtaining services or purchasing products from a business, or for obtaining additional information from the business about current or future events or conditions, it should be appreciated by those having skill in the art that registration may also be used by business to, for example, track their own employees or control energy usage within the business.

For example, the network may be set up to provide information regarding the availability of certain individuals within a particular business. If an individual is not located within the business, his smart phone or WiFi enabled device will not be in communication with the network routers or access points at the business and such information can be made immediately apparent to individuals, be they consumers, co-workers, or superiors, looking for the individual. The information may be either transmitted to all or certain individuals that a particular individual is not available, by for example transmitting a message when the individual is no longer detected by the system, or instead by linking the network to a display showing which individual's WiFi devices are currently being detected by the network and which are not.

Configuring a network to report on the availability of individuals within a particular business may also track how long the employee's WiFi device is in the building and act as a time sheet or the like. Utilizing such a feature eliminates the need for employees to have to spend time filling out and turning in timesheets, increasing their productivity and reducing the amount of time they have to spend in the office. Tracking individual WiFi devices also gives the business a failsafe way of insuring that employees are paid only for the time they are actually at work. Such a system may also be configured to “punch-out” employees located in a specific area, like for example a cafeteria or break room. Tracking such may reward employees for taking shorter breaks or shorter lunches while insuring that employees who take longer breaks or longer lunches are paid accordingly.

Businesses connected to the network may also be able to track the actions of transient employees as well. If a particular employee is out on a job in a remote location that is registered with the network, the network will track the amount of time the employee is within the business they are working at remotely.

An additional use for tracking an employee within a business is to enhance energy conservation. In some embodiments, the network routers or access points may be configured to track each employee's smart phone or other WiFi device, like for example a company issued WiFi card. If for any set period of time, the network fails to receive a signal from one smart phone or WiFi device in the business or a particular room, area, or building in the business, the network may be configured to communicate with, for example, the light control for the area, building, or particular room in the building and direct the lights to shut off or the air conditioning or heat to adjust to save energy. In some embodiments the network may be configured to provide a message to a particular smart phone or WiFi device that has not moved for a period of time to insure an employee or consumer is with the device and that it wasn't left behind. In such embodiments, the employee or consumer may be required to respond to the message or move the device in order to prevent the network from controlling a building element, like for example, shutting off the lights.

Tracking an employee within a business may also eliminate the necessity for identification badges, key fobs or any other electronic key passes. If each employee, consumer, or individual who has been granted access to a particular business or a particular area of a business has a registered smart phone or WiFi device, rather than have to keep a separate access key or card, the individual's smart phone or WiFi device may control the entry point. For example, if access to a particular business is limited to only employees, each employee's smart phone or WiFi device may be registered with the network and when the employee approaches an entrance a router or access point may be configured to recognize the smart phone or device and transmit a signal to the entry point, like for example an electronically locked door, to open and allow the individual to pass through. If particular rooms or areas within a business are restricted access, the network may be configured to deny access to the restricted areas to any individuals not carrying a WiFi device approved for access.

For business who wish to track their employees for any of the reasons above, it should be appreciated that WiFi identification cards may be provided to any individual or employee entering the premises who does not have a smart phone or WiFi device or does not want to register their personal smart phone or WiFi device with the network. A WiFi identification card may have all of the capabilities discussed herein, however it is contemplated that the WiFi card may simply allow for network detection and provide only what is necessary for automated network responses and not provide any ability of the user to provide responses to the network.

It should be appreciated by those having ordinary skill in the art that while some of the aforementioned features are described for businesses, like for example energy control or electronic lock access, that these features may also be used in private residences where energy consumption or electronically locked doors are desired or used. Additionally, in homes seeking control access or use of certain electronic devices or limit access to certain television programs or the like, household appliances may be controlled by the network. In order to do so, a homeowner would be required to register their home with the network, receive a router for controlling the desired utilities or devices, and set router controls in the network/server permitting or denying access to certain rooms, devices to instances when only approved WiFi devices are located within certain proximity of the device. Incorporating such control within a home would require connecting the router or access point to each device, door, or utility the homeowner sought to control.

While an individual registering their WiFi device insures that the individual will receive maximum content from the network when in business which have registered with the network and gives the registered individual control over what content they will receive, in some embodiments the routers or access points configured within a business may be configured to provide a generic greeting or other additional content, messages, or information to each individual who enters the business with an active WiFi device, regardless of whether they are registered or not.

Since each WiFi device contains a unique MAC address, unregistered devices detected by the network through any router may be tracked as an individual moves around a business or purchases items. Tracking allows for the network to provide an individual who decides to join the network at a later time with the opportunity to be selected for special discounts or rewards based on previous purchases.

Regardless of whether an individual is registered or not, the network may be configured so that each individual router or access point at a particular business or a chain of businesses has a short term memory which tracks individuals who have visited the business that day to provide a specific welcome back message or track the activity of the individual to make the purchasing process easier. In single stores a simple welcome back message may be conveyed or if a particular item was ordered and an in store pick up is to be completed and the item can be provided to the consumer. In stores having more than one location the network may be configured so that if a consumer goes to one particular store looking to purchase an item and that store is sold out of the item but another store in the chain has the item in stock, a message may be provided to the network that if the consumer visits the other store, the item be presented to the consumer for purchase upon entry.

In order to provide access to the system to individuals, each business may purchase a kit containing one or more routers containing the SSID number, and be provided with a unique identification or password for logging into the system and providing the server with business specific messages for individuals who enter the business. The kit may additionally include a back up power supply for one or more of the routers.

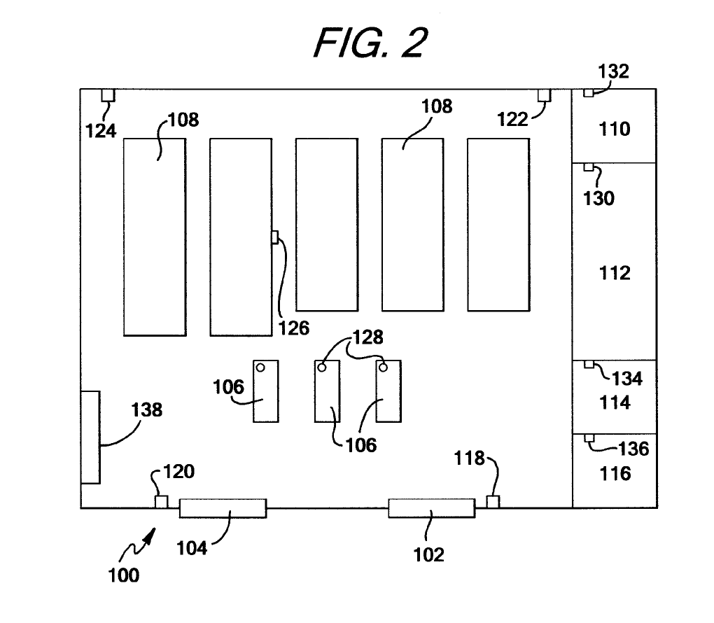

FIG. 2 shows an exemplary embodiment of a registered business set up with the network routers. As seen in FIG. 2, business 100 has doors 102, 104, check out counters 106, aisles 108, office 110, break room 112, and bathrooms 114, 116. Within building 100, proximate doors 102, 104 are routers or access points 118, 120. As discussed herein these access points may provide messages to individuals entering or exiting the premises, and may be further configured to provide periodic messages to registered individuals as they travel throughout the store, or as individuals approach known locations near specific products.

In addition to access points 118, 120, access points 122, 124 may be provided to create a mesh over the store floor. As described above utilizing multiple access points like 118, 120, 122, and 124 allows for easier distribution of content to individuals in the business, and allows for better tracking of individuals as they pass through the business. In addition to providing messages and tracking locations, any of access points 118, 120, 122, and 124 may control utilities within the business and allow for automated tracking of employee movement.

As discussed above, business 100 may also include an access point 126 located in an aisle 108 proximate a specific product or piece of information the business wants to particularly notify an individual about. Access point 126 may be a standard access point capable of transmitting anywhere within the business, or may be a beacon access point capable of only transmitting its signal as an individual with a WiFi device comes with in a certain predetermined range.

As seen in FIG. 2, business 100 may also include access points 128 located proximate check out counters 106. Access points 128 may be utilized to detect very locally located WiFi devices registered on the network to facilitate payment or prevent payment fraud, as discussed above, or may be utilized to detect registered individual's WiFi devices in order to insure all store discounts are applied to the registered individual's purchases and that all rewards points are accredited to the registered individual. In order to do so, it should be appreciated by those having skill in the art that access points 128 may be linked to a cash register or computer handling the transaction so that the access points 128 may obtain the amount paid, the items purchased, or any other relevant information and transmit the same to the network server for storage. As described herein, access point 128 may also be configured to detect unregistered individual and transmit their purchase information associated with the WiFi device with the individual to the server for storage for future discounts if the unregistered individual ever registers.

As seen in FIG. 2, additional access points 130, 132, 134, and 136 may be placed in break room 112, office 110, and bathrooms 114, 116 respectively to further track movement of individuals located within business 100. As described above, these access points may additionally be used to track movements of employees for calculating time worked, and may also be linked to utilities in the individual rooms, like for example the lights, to allow automated control as WiFi devices pass in and out of the rooms.

Business 100 may further include display 138 for providing an indication of which employees are currently within the confines of the business. Since each employee WiFi enabled device has a specific MAC address or other unique electronic ID, the server is capable of detecting which specific employees are located within the network at business 100. Any of access points 118, 120, 122, or 124 may be linked to display 138 to provide information from the server of which employees are currently at the business. Alternatively, display 138 may be linked directly to the server and receive nearly instantaneous updates directly from the server as employees move in and out of the business.

While in the foregoing there has been set forth a preferred embodiment of the invention, it is to be understood that the present invention may be embodied in other specific forms without departing from the spirit or central characteristics thereof. The present embodiments, therefore, are to be considered in all respects as illustrative and not restrictive, and the invention is not to be limited to the details given herein. While specific embodiments have been illustrated and described, numerous modifications come to mind without significantly departing from the characteristics of the invention and the scope of protection is only limited by the scope of the accompanying Claims.

I claim:

1. A method for tracking and communicating with individuals located within a business, the method comprising:
registering a business with a server controlling a network;
placing at least one router having in communication with the server in the business;
uploading at least one message to the server from the at least one business; and,
transmitting the at least one message from the at least one router at to active WiFi devices of individuals located within the business.

2. The method of claim 1 further comprising the step of placing at least two routers having a common SSID in communication with the server in at least one business.

3. The method of claim 2 further comprising the step of uploading messages to the server specific to each of the at least two routers in communication with the server.

4. The method of claim 1 further comprising the step of uploading messages to the server through a computer connected to the internet.

5. The method of claim 1 further comprising the step of uploading messages to the server through direct entry by a party remote from the at least one business.

6. The method of claim 5 further comprising the step of communicating the messages to be uploaded to the server by the remote party by phone.

7. The method of claim 5 further comprising the step of communicating the messages to be uploaded to the server by the remote party by email.

8. The method of claim 1 further comprising the step of providing the at least one business with a unique identification for logging into the server.

9. The method of claim 8 further comprising the step of providing the at least one business with a unique password for logging into the server.

10. The method of claim 1 further comprising the step of providing messages specific to select WiFi devices.

11. The method of claim 11 further comprising the step of selecting the WiFi devices based on referrals by consumers owning WiFi devices to new consumers owning additional WiFi devices.

12. The method of claim 12 further comprising the step of providing the messages specific to the select WiFi devices after the additional internet ready devices are registered with the server.

13. The method of claim 11 further comprising the step of selecting the WiFi devices based on previous purchases.

14. The method of claim 1 further comprising the step tracking a location of each WiFi device within a business through the at least one router.

15. The method of claim 1 further comprising the step of tracking a total number of WiFi devices within a business.

16. The method of claim 1 further comprising the step of identifying specific WiFi devices within the business.

17. The method of claim 16 further comprising the step of identifying employee WiFi devices within the business.

18. The method of claim 17 further comprising the step of tracking the amount of time each employee WiFi device is located in the business each day.

19. The method of claim 17 further comprising the step indicating each employee WiFi device located in the business.

20. The method of claim 1 further comprising the step of linking at least one building utility with the at least one router.

21. The method of claim 20 further comprising the step of controlling the at least one building utility with the at least one router based on at least one of the number or location of WiFi devices located in the business.

22. The method of claim 21 further comprising the step of controlling lights with the at least one router.

23. The method of claim 21 further comprising the step of controlling heating or air conditioning with the at least one router.

24. The method of claim 1 further comprising the step of transmitting real-time updates based on a status or condition in the at least one business.

25. The method of claim 1 further comprising the step of tracking and storing items purchased by each WiFi device in the at least one business.

26. The method of claim 1 further comprising the step of tracking and storing all WiFi devices which enter a business within each 24-hour period.

27. The method of claim 1 further comprising the step of linking an electronic door lock to the at least one router.

28. The method of claim 27 further comprising the step of controlling an electronic door lock with the at least one router.

29. A method of receiving messages from a business via a WiFi enabled device while located in the business, the method comprising the steps of:
registering at least one WiFi device with a server controlling a network;
entering a business connected to the server and the network with the at least one WiFi device.

30. The method of claim 29 further comprising the step of registering a smart phone with the server.

31. The method of claim 29 further comprising the step of registering a PDA with the server.

32. The method of claim 29 further comprising the step of registering a tablet computer with the server.

33. The method of claim 29 further comprising the step of registering a laptop computer with the server.

34. The method of claim 29 further comprising the step of receiving a WiFi identification card pre-registered with the server.

35. The method of claim 29 further comprising the step of providing additional personal information when registering the at least one WiFi device.

36. The method of claim 35 further comprising the step of providing at least one from the group consisting of a name of an owner of the at least one WiFi device; a phone number associated with the at least one WiFi device; an email address associated with the at least one WiFi device; a list of products or services the owner of the at least one WiFi device may be interested in.

37. The method of claim 35 further comprising the step of linking a payment method to the at least one WiFi device.

38. The method of claim 37 further comprising the step of linking a debit card to the at least one WiFi device.

39. The method of claim 37 further comprising the step of linking a credit card to the at least one WiFi device.

40. The method of claim 29 further comprising the step of transmitting a message from the WiFi device to the at least one router in response to the at least one message transmitted by the router.

41. The method of claim 29 further comprising the step of assigning a unique network ID to each WiFi device registered with the server.

42. A system for enabling communication between a business and consumers located within the business, the system comprising:
at least one server for registering and storing at least one consumer WiFi capable device mac addresses;
at least one message uploaded by a business to the server for transmission to the at least one consumer WiFi capable device; and,
at least one router in communication with the at least one server for direct transmission of the at least one message uploaded by the business with the at least WiFi capable device when it is located in the business.

43. A kit for communicating with consumers located within a business, the kit comprising:
at least one router containing an SSID number in communication with a central server for placement in a business, the router being configured to communicate with WiFi devices located in the business or within a predetermined distance from the router.

44. The kit of claim 42 further comprising at least two routers, each of the at least two routers in communication with each other.

45. The kit of claim 43 wherein at least one of the at least two routers is connected to the internet.

46. The kit of claim 42 further comprising a back up power supply for the at least one router.

47. The kit of claim 45 wherein the back up power supply is a battery.
